(19) United States
(12) Patent Application Publication
(10) Pub. No.: US 2021/0133747 A1
(43) Pub. Date: May 6, 2021

(54) SYSTEMS AND METHODS FOR AUTHENTICATION USING A DYNAMIC PERSONAL IDENTIFICATION NUMBER

(71) Applicant: Red Dwarf Studios, LLC, Carefree, AZ (US)

(72) Inventors: Eric Jacob Classen, Scottsdale, AZ (US); Mark David Rodriguez, Scottsdale, AZ (US)

(21) Appl. No.: 16/927,721

(22) Filed: Jul. 13, 2020

Related U.S. Application Data
(60) Provisional application No. 62/873,134, filed on Jul. 11, 2019.

(51) Int. Cl. G06Q 20/40; G06F 21/45; G06Q 20/08; G06Q 20/02; G06Q 20/38; G06Q 20/20; G06F 16/23

(52) U.S. Cl. CPC G06Q 20/4012; G06F 21/45; G06Q 20/085; G06Q 2220/00; G06Q 20/389; G06Q 20/202; G06F 16/2379; G06Q 20/02

(57) ABSTRACT

Methods and systems are provided herein for authenticating account holders using dynamic PINs. The methods may include receiving a transaction request from a vendor with the transaction request including a security number. The security number may be associated with an account holder. A dynamic PIN may be generated based at least in part on the time. The method may match the dynamic PIN to the security number associated with the account holder. The method may also include approving the transaction request from the vendor in response to the dynamic PIN matching the security number associated with the account holder. The method may further include the steps of generating a block including transaction information in response to the transaction request, broadcasting the block to a network for approval, adding the block to a blockchain in response to the approval, and generating the dynamic PIN.

### FIELD

The present application claims the benefit of and priority to U.S. Provisional Patent Application No. 62/873,134 filed Jul. 11, 2019, the entire contents of all which are incorporated by reference herein.

The present disclosure relates generally to authentication using a dynamic Personal Identification Number (PIN).

### BACKGROUND

Fraudulent transactions result in substantial financial losses for banks, credit card issuers, business, and consumers alike. Fraudulent purchases can happen when wrongdoers obtain purchase account information belonging to another, such as credit card or account numbers. Advances in card technology such as CCV numbers, PIN, and chip cards have reduced fraud over time by improving authentication of people executing transactions.

Some Vendors authenticate users by requesting a security number printed on the back of a credit card and verifying the security number with the bank. Other vendors request a signature that matches the signature on the back of the card. Still other vendors require transactions with chip cards. Despite these efforts to reduce credit card fraud, fraudulent buyers still succeed in compromising accounts. These fraudulent card users can acquire the security code printed on the card or the PIN used in plain sight or on a compromised terminal, for example. Sometimes account holders lose their transaction cards after writing the static PIN on the back. Security protocols based on static security codes are at increasing risk of compromise as time passes.

### SUMMARY

The present disclosure relates to methods and systems for authenticating account holders using dynamic PINs. The method may include receiving a transaction request from a vendor with the transaction request including a security number. The security number may be associated with an account holder. A dynamic PIN may be generated at least in part based on the time. The method may match the dynamic PIN to the security number associated with the account holder. The method may also include approving the transaction request from the vendor in response to the dynamic PIN matching the security number associated with the account holder.

In various embodiments, the method may further include the steps of generating a block including transaction information in response to the transaction request, broadcasting the block to a network for approval, adding the block to a blockchain in response to the approval, and generating the dynamic PIN in response to adding the block to the blockchain.

In various embodiments, the personal identification number may be generated based on a current time. The personal identification number may include a three-digit number for entry in a point-of-sale device or a five-digit number for entry in response to a prompt for a zip code. The method may also include the step of generating the dynamic PIN using a consumer profile associated with the account holder.

Additional aspects and advantages of the present disclosure will become readily apparent to those skilled in this art from the following detailed description, wherein only exemplary embodiments of the present disclosure are shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION

The features and advantages of the present disclosure will become more apparent from the detailed description set forth below when taken in conjunction with the drawings. The left most digit of a reference number identifies the drawing in which the reference number first appears.

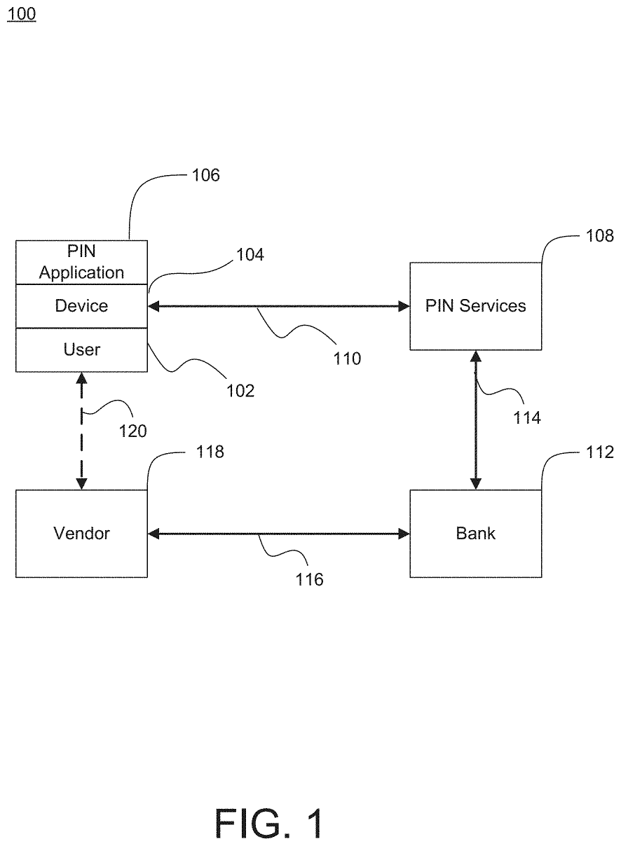

FIG. 1 illustrates a system for completing transactions using a dynamic PIN to authenticate an account holder, in accordance with embodiments.

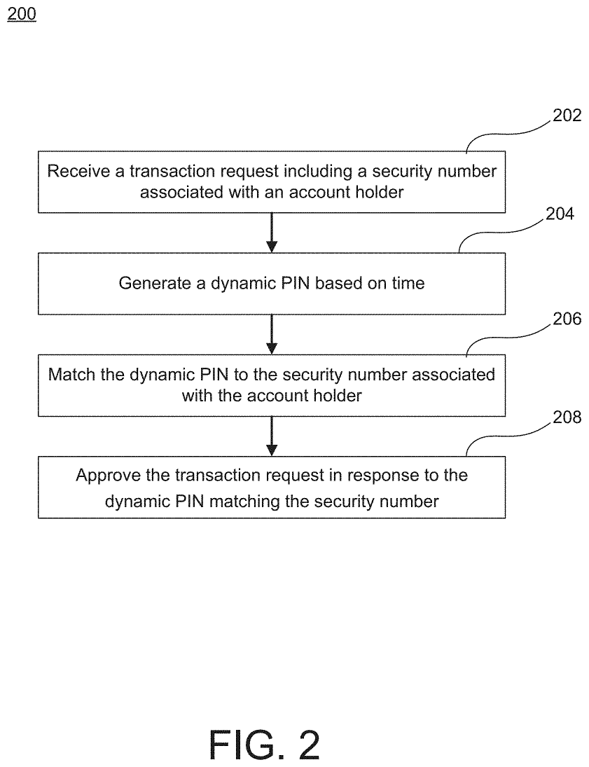

FIG. 2 illustrates a process for authenticating an account holder using a dynamic PIN, in accordance with embodiments.

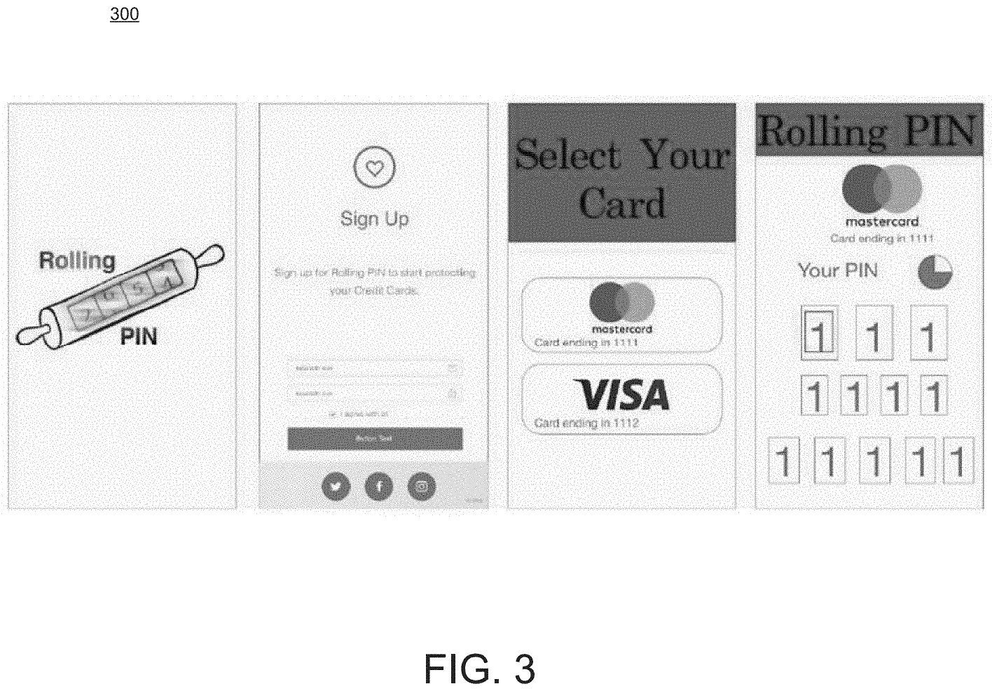

FIG. 3 illustrates a user interface for retrieving a dynamic PIN, in accordance with various embodiments.

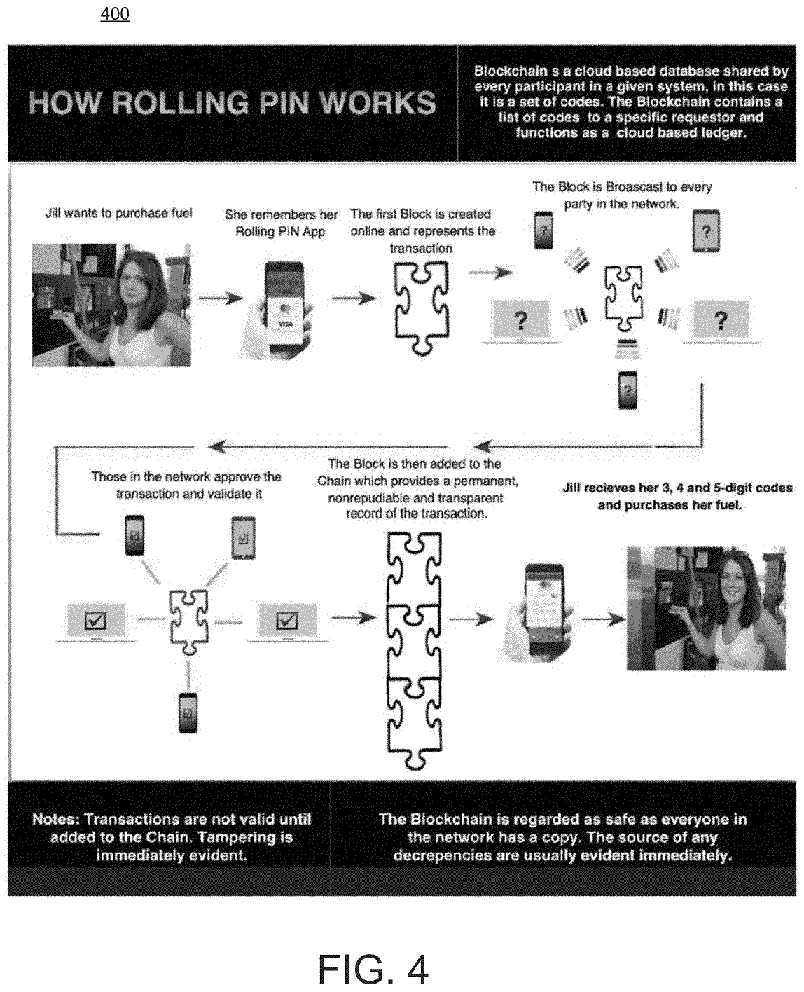

FIG. 4 illustrates a process for completing a transaction using a dynamic PIN, in accordance with embodiments.

### DETAILED DESCRIPTION

The present disclosure generally relates to authentication system. The authentication system may leverage or confirmation authentication using a dynamic Personal Identification Number (PIN). The detailed description references the accompanying drawings, which show the exemplary embodiments by way of illustration. While these exemplary embodiments are described in sufficient detail to enable those skilled in the art to practice the disclosure, it should be understood that other embodiments may be realized and that logical and mechanical changes may be made without departing from the spirit and scope of the disclosure.

Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

The phrases user, consumer, customer, account holder, account affiliate, cardmember or the like may be used interchangeably and shall include any person, group, entity, business, organization, business, software, hardware, machine and/or combination of these, and may, in various embodiments, be associated with a transaction account, buy merchant offerings offered by one or more merchants using the account and/or be legally designated for performing transactions on the account, regardless of whether a physical card is associated with the account. For example, a consumer or account affiliate may include a transaction account owner, a transaction account user, an account affiliate, a child account user, a subsidiary account user, a beneficiary of an account, a custodian of an account, and/or any other person or entity affiliated or associated with a transaction account.

Phrases and terms similar to “account,” “transaction account,” “account number,” “account code,” and/or “consumer account” may include any account that may be used to facilitate a transaction (e.g., financial transaction). These accounts may include any device, code (e.g., one or more of an authorization/access code, dynamic PIN, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards account, charge account, credit account, debit account, prepaid account, telephone card, embossed card, smart card, magnetic stripe card, bar code card, transponder, radio frequency card and/or an associated account.

A bank may be part of the systems described herein, and the bank may, in various embodiments, represent other types of card issuing institutions, such as credit card companies, card sponsoring companies, or third-party issuers under contract with financial institutions. It is further noted that other participants may be involved in some phases of a transaction, such as an intermediary settlement institution.

Phrases and terms similar to “business,” “merchant,” “vendor,” or “Service Establishment” may be used interchangeably with each other and shall mean any person, entity, distributor system, software and/or hardware that is a provider, broker and/or any other entity in the distribution chain of goods or services. For example, a merchant may be a grocery store, a retail store, a restaurant, a travel agency, a service provider, an online merchant and/or the like. In various embodiments, a merchant may request payment for goods and/or services sold to a customer or consumer who holds an account with a transaction account issuer.

Terms such as “transmit,” “communicate” and/or “deliver” may include sending electronic data from one system component to another over a network connection. Additionally, as used herein, “data” may include information such as commands, queries, files, data for storage, and/or the like in digital or any other form.

A “transaction” may include one or more approved authorizations. Moreover, the phrase “transaction data” may comprise data associated with one or more transactions. In various embodiments, an authorization may be approved by a payment processor in response to a transaction request, which may be initiated by a consumer and/or a merchant.

Phrases and terms similar to “item” may include any good, service, information, experience, data, content, access, rental, lease, contribution, account, credit, debit, benefit, right, reward, points, coupons, credits, monetary equivalent, anything of value, something of minimal or no value, monetary value, offer, merchant, type of merchant, demographic data, preference data, consumer profile data, consumer profile, type of transaction account, transaction account, period of time (e.g., a period of time a consumer has been a customer of a transaction account issuer), size of wallet, share of wallet, information, and/or the like. Further, in various embodiments, an item may comprise an input to and/or an output of a collaborative filtering or recommendation algorithm.

With further regard to the types of data which may be contributed to a consumer profile, in general, any information that a consumer would like to serve as a basis for a consumer profile may be contributed. For instance, a consumer profile may comprise location data (e.g., data associated with a global positioning system, a home address, a work address, family location data, data about a consumer's most shopped or favorite shopping locations, data about a consumer's most visited or favorite places), data associated with a consumer's favorite websites, digital destinations, or magazines (e.g., blogs, news websites, shopping websites, research websites, financial websites, etc.), personal data (e.g., email addresses, physical addresses, phone numbers, age information, income information, expenses information, etc.), data associated with a consumer's status or mode of travel (e.g., vacation data, business data, personal data, airline data, lodging data, etc.), data associated with a consumer's favorite items (e.g., food, restaurants, groceries, electronics, music, gaming, clothing types, hobbies, fitness, etc.), and/or the like.

A transaction record, transaction request, or other information associated with a transaction and/or a dynamic PIN may be recorded as part of a block in an immutable database in the form of a blockchain. A blockchain is a list of records linked together using cryptography. Each block points to the previous block using a cryptographic hash of information associated with previous blocks, timestamps, transaction data, or other data written to the blockchain.

A “channel” may include any system or method for delivering content and/or a dynamic PIN as described below. Content may be presented in any form or medium, and in various embodiments, the content may be delivered electronically and/or capable of being presented electronically in response to a transaction using a dynamic PIN. For example, a channel may comprise a website, a uniform resource locator (“URL”), a document (e.g., a Microsoft Word document, a Microsoft Excel document, an Adobe pdf document, etc.), an “ebook,” an “emagazine,” an application, a text message, an email, and/or the like. In various embodiments, a channel may be hosted or provided by a data partner. Further, in various embodiments, a channel may comprise a social media channel, such as FACEBOOK, FOURSQUARE, TWITTER, or the like.

A “consumer profile” or “consumer profile data” may comprise any information or data about a consumer that describes an attribute associated with the consumer (e.g., a preference, an interest, demographic information, personally identifying information, and/or the like). In various embodiments, a consumer profile may be based upon a variety of data. For example, a consumer profile may be based upon data that is received, culled, collected, and/or derived from a variety of sources, such as a consumer's transaction history, data associated with or available via a consumer's social networking profile (e.g., a consumer's FACEBOOK profile), data associated with a customer's physical location, and/or other publicly and/or privately available sources of information about a consumer. In various embodiments, a consumer profile may not be based upon such data, unless a consumer opts in or requests that such data be used.

In various embodiments, the authentication systems and methods described herein, may be deployed in any suitable environment. Moreover, the authentication systems and methods may leverage dynamic authentication elements including, for example, a dynamic PIN. The authentication systems described herein may be capable of determining a requested data element at a kiosk (e.g., a requested PIN at an ATM or a requested zip code at a gas pump) and dynamically adjust a PIN to conform with the requested data element (e.g., a 3 digit dynamic PIN, a 5 digit dynamic PIN, and/or the like). The requested authentication systems may also be configured to capture, assess, verify, authenticate, and/or validate the requested data element provided through the user at the kiosk. In this regard, the authentication system may be configured to delivery validation information to a user bank or other suitable control entity without providing actual card, account or personal information. The authentication system may be scaled or deployed in any suitable environment that requires validation including, for example, for financial transactions, for access (e.g., to a home, apartment, work site, access to a computer or other electronic device, or other premises), for identify validation, and/or the like.

Accordingly, and with reference to FIG. 1, an exemplary authentication system 100 is shown for authenticating account holders or authorized account users using a dynamic PIN, in accordance with various embodiments. User 102 may operate device 102. Device 102 may comprise, for example, a mobile phone, tablet, computer, Internet-of-Things (IoT) device, smart appliance, game console, laptop, point-of-sale device, terminal, vehicle display, or any other computing device capable of communicating over an electronic network. Device 102 may include one or more browsers or browser applications and/or application programs, including browser applications comprising Internet browsing software installed within a computing unit or a system to conduct online transactions and/or communication.

In various embodiments, device 102 may run application 106. Application 106 may be a stand-alone application or may be a bank application with the PIN features described herein embedded in the bank application. Application 106 may comprise logic capable of generating, requesting, and/or receiving a dynamically-generated PIN, also referred to herein as a dynamic PIN. PIN Application 106 may comprise a software token application that provides a Time-based One-Time PIN Code algorithm (TOTP) and/or HMAC-based One-time Code Algorithm (HOTP), for authenticating mobile users. A dynamic PIN may comprise a unique set of numbers, letters, and/or symbols (e.g., a three, four, five, six, seven, or n-digit code) that may be used to authenticate users during transactions conducted by account holders such as user 102. Dynamic PINs may also be used by locking devices that utilize a PIN Code or other code for security authentication.

For more information on TOTP, see RFC 6238 as documented by the Internet Engineering Task Force at https://tools.ietf.org/html/rfc6238. For more information on HOTP, see RFC 4226 as documented by the Internet Engineering Task Force at: hasps://tools.ietf.org/html/rfc4226. RFC 6238 and RFC 4226 are incorporated herein by reference in their entirety.

In various embodiments, device 102 may be in electronic communication with PIN services 108 over network 110. PIN services 108 may comprise one or more servers or cloud computing systems configured to support PIN application 106 running on device 104. In this regard, PIN services 108 may be operated by a control entity which may include, for example, bank 112, a transaction acquirer, a merchant services company, a credit card issuer, a third-party service provider, a PIN service provider, or other suitable entity. PIN services 108 may thus be in electronic communication with the control entity over network 114.

In various embodiments, operation of the authentication system may be described in the context of a purchase transaction for an item. In this regard, vendor 118 may offer goods and services for purchase. User 102 may purchase from vendor 118 in person, on a web page, through a third-party intermediary, through an app store, or through any other suitable purchasing channel. Vendor 118 may authorize transactions by communicating with bank 112 electronically across network 116.

PIN services 108, bank 112, and/or vendor 118 may each operate a computing device that interact in system 100. In that regard, it may be understood that PIN services 108, bank 112, and/or vendor 118 as illustrated in FIG. 1 each represent one or more computing devices in electronic communication across network 110, network 114, and/or network 116.

Network 110, network 114, and/or network 116 may include any electronic communications system or method which incorporates hardware and/or software components (e.g. a “cloud” or “cloud computing” system, as described herein). Communication among parties via networks may be accomplished through any suitable communication channels, such as, for example, a telephone network, an extranet, an intranet, Internet, point of interaction device (e.g., a point of sale device, a smartphone, kiosk, and/or the like), online communications, satellite communications, off-line communications, wireless communications, transponder communications, local area network (LAN), wide area network (WAN), virtual private network (VPN), networked or linked devices, keyboard, mouse and/or any suitable communication or data input modality.

Moreover, although the system 100 is frequently described herein as being implemented with TCP/IP communications protocols, the system may also be implemented using IPX, APPLETALK, IP-6, NetBIOS, OSI, any tunneling protocol (e.g. IPsec, SSH), or any number of existing or future protocols. If network 110 is a public network, such as the Internet, it may be advantageous to presume network 110 to be insecure and open to eavesdroppers. Thus, a dynamic PIN may be computed locally at PIN application 106, pin services 108, bank 112, and/or vendor 118 to avoid transmitting a calculated dynamic PIN across an open communication channel.

The various system components may be independently and separately or collectively suitably coupled to network 110, network 114, and/or network 116 via data links which include, for example, a connection to an Internet Service Provider (ISP) over the local loop as is typically used in connection with standard modem communication, cable modem, a satellite network, ISDN, Digital Subscriber Line (DSL), or various wireless communication methods. Moreover, this disclosure contemplates the use, sale or distribution of any goods, services or information over any network having similar functionality described herein.

As used herein, a “cloud” or “cloud computing” may describe a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see NIST's (National Institute of Standards and Technology) definition of cloud computing published as SP 800-145 and available at https://csrc.nist.gov/publications/detail/sp/800-145/final, which is hereby incorporated by reference in its entirety.

In various embodiments, application 106 may generate a dynamic PIN using a predetermined algorithm with one or more dynamic (i.e., changing) inputs and/or requests (e.g., the request from a kiosk where a user is attempting to complete a transaction). The dynamic PIN may comprise any suitable number, letter, and/or symbol combination one-time code for use in conjunction with a transaction (e.g., bank card Non-chip and CHIP transactions). Application 106 may thus generate or receive a set of dynamic PINs (i.e., one-time codes) for each transaction. Application 106 may also be configured to parse and analyze a pin request in response to user 112 initiating a transaction. In this regard, application 106 may be configured to determine the nature of the requested input needed to complete the transaction (e.g., a ccv code, a zip code, a phone number, and/or the like). In response to this determination by application 106, application 106 and/or PIN service 108 may generate a dynamic pin that confirms with the request for each transaction. User 102 may enter the unique codes into the merchant's card terminal or where the user swipes, inserts the CHIP Card, or makes a phone or internet purchase. The dynamically generated codes enhance security by inhibiting PIN theft.

In various embodiments, various transactions may use a security code (e.g., three-digit PIN or four-digit PIN) depending on preferences of bank 112 the control entity. For example, PIN application 106 may generate a unique 3-digit dynamic PIN for VISA, MASTERCARD, and DISCOVER accounts but a four-digit dynamic PIN for AMERICAN EXPRESS accounts. User 102 may select the account to use at the time of purchase through PIN application 106 on device 104. In another example, zip-code-authorized transactions may accept a 5-digit dynamic PIN in lieu of the actual zip code for user 102. PIN application 106 may also display a set of codes for the user to choose from for each transaction.

In various embodiments, user 102 may open application 106 for each transaction via the device 104. Upon opening PIN application 106, user 102 may be authenticated using a code, password, biometric, or other authentication technique. Biometric authentication techniques may include facial recognition, fingerprints, retina scans, vocal matching, touch gestures, or other authentication techniques based at least in part on unique or semi-unique characteristics of user 102.

In various embodiments, system 100 may be compatible with various operating systems for mobile and other computing devices such as, for example, iOS, Windows, Android, Linux, or other mobile operating systems. System 100 may thus be compatible with mobile payment systems such as, for example, Apple Pay, Google Wallet, SAMSUMG Pay, FitBit Pay, PayPal, Venmo, Zelle, or other mobile payment platforms. System 100 may also support transaction accounts such as, for example, Visa, MasterCard, Discover, American Express, Diners Club, PayPal, JCB, UATP or other transaction accounts.

Referring now to FIG. 2, process 200 is shown for authenticating user 102, in accordance with various embodiments. Bank 112, PIN services 108, and/or application 106 may receive a transaction request from vendor 118 (Block 202). The transaction request may include a security number such as a dynamic PIN entered in place of a static PIN by user 102. User 102 may enter the dynamic PIN at point-of-sale 120, for example. User 102 may retrieve the dynamic PIN for entry in place of the static PIN using PIN application 106.

In various embodiments, bank 112, PIN services 108, and/or application 106 may generate a dynamic PIN based on time (Block 204). The dynamic PIN may be generated using TOTP and/or HOTP. The dynamic pin may be generated using an algorithm that takes time and a seed or other information from a consumer profile (i.e., information associated with the transaction account of user 102).

In various embodiments, bank 112, PIN services 108, and/or application 106 may match the dynamic PIN to the security number associated with the account holder. The match may be an exact match. The dynamic PIN may also comprise several numbers generated with times from an interval with a single one of the several numbers matching the security number associated with the account holder.

In various embodiments, bank 112, PIN services 108, and/or application 106 may approve the transaction request from the vendor in response to the dynamic PIN matching the security number associated with the account holder. The use of a dynamically generated PIN to authenticate user 102 thus enhances security associated with purchase transactions.

With reference to FIG. 3, an exemplary interface 300 is shown for using system 100 and/or process 200, in accordance with various embodiments. User may install PIN application 106 on a smartphone. PIN application 106 may be a stand-alone application or may be offered by bank 112 or another suitable control entity. Once the PIN application 106 is downloaded and/or active, user 102 may create an account and enter the account information for transaction accounts or access.

In various embodiments, PIN application 106 may be active and ready for use in response to installation on device 104 and entry of account information. User 102 may open PIN application 106 triggering a prompt with a menu of transaction accounts selectable with a touch button or other interface, as shown in FIG. 4. PIN application 106 may present a next screen in response to user 102 selecting a transaction account. PIN application 106 may display one or more dynamic PIN (e.g., one-time codes) for the selected transaction account. The dynamic PIN may be valid for a limited interval. The interval may be, for example, 30 seconds, one minute, five minutes, ten minutes, or another fixed interval. The interval may also be dynamically selected based on a risk evaluation associated with the transaction or access request. In some embodiments, the interval may be determined by the user. In other embodiments, the interval may be established by the control entity or by bank 112.

In various embodiments, user 102 may select one or more codes presented by PIN application 106. The codes may range from three-, four-, and five-digits that replaces a PIN, security code and zip code, for example. The codes presented by PIN application 106 and entered by user 102 may be verified by bank 112. Bank 112 may calculate the codes using the same algorithm and inputs to verify the codes and authenticate user 102.

In various embodiments, PIN application 106 may be used in conjunction with locking and unlocking physical locks using a dynamic PIN. For example, PIN application 106 may be used to unlock IoT Devices that requires a security code. PIN application 106 may also be used in conjunction with commercial, military and non-commercial electronic keyless entry applications such as, for example exterior locks for motor vehicles, business and home locks, and other suitable aircraft, automobile, and marine security systems.

In various embodiments, user 102 may use interface 300 of a stand-alone PIN application 106. User 102 has downloaded the PIN Application 104 on her device, as she has heard it will protect her credit cards. Once downloaded, user 102 opens the app and enters her transaction accounts into PIN application 106. PIN application 106 displays multiple (e.g., a 3, 4 & 5-digit) TOTP and HOTP dynamically-generated code for each transaction.

In various embodiments, User 102 may open her PIN application 106 (e.g., her bank application on her smartphone with embedded dynamic PIN functionality. She opens the app and it provides multiple (e.g., a 3, 4 & 5-digit) dynamically-generated codes for each transaction.

With reference to FIG. 4, process 400 is shown for authenticating user 102 using system 100, in accordance with various embodiments. User 102's car may be low on fuel causing user 102 to stop into a gas station to refuel. At the pump user 102 may insert her Chip Card and is prompted to perform a Credit Card or a Debit Card transaction. User 102 may choose the Credit Option by choosing the 4-digit code which replaces the traditional security PIN with a random number that is generated by PIN application 106 in real-time through an API (Application Programming Interface) or software embedded within the banks credit card network, which may trigger a display the options on the device 104. User 102 may unlock her device using the biometric authentication or the device's security code. User 102 may open PIN application 106 (e.g., standalone application or bank application). PIN application 106 may prompt for authentication using biometrics or the device's security code. Once the app is open it provides a 1-time 3, 4, and 5-digit codes to complete each transaction (e.g., 1. Zip code—unique 5-digit code 2. Security PIN—unique 4-Digit code 3. CCV—unique 3-digit code 4. CCV—unique 4-digit code).

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

As will be appreciated by one of ordinary skill in the art, the system may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet-based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and/or the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” should be construed to exclude only those types of transitory computer-readable media which were found in In Re Nuijten to fall outside the scope of patentable subject matter under 35 U.S.C. § 101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, “including” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method comprising:
receiving, by a computer-based system, a transaction request from a vendor, wherein the transaction request includes a security number associated with an account holder;
generating, by the computer-based system, a dynamic PIN based on a time;
matching, by the computer-based system, the dynamic PIN to the security number associated with the account holder; and
approving, by the computer-based system, the transaction request from the vendor in response to the dynamic PIN matching the security number associated with the account holder.

2. The method of claim 1, further comprising:
generating, by the computer-based system, a block including transaction information in response to the transaction request;
broadcasting, by the computer-based system, the block including the transaction information to a network for an approval;
adding, by the computer-based system, the block to a blockchain in response to the approval;
generating, by the computer-based system, the dynamic PIN in response to adding the block to the blockchain.

3. The method of claim 1, wherein the personal identification number is generated based on a current time.

4. The method of claim 1, wherein the personal identification number comprises a three-digit number for entry in a point-of-sale device.

5. The method of claim 1, wherein the personal identification number comprises a five-digit number for entry in response to a prompt for a zip code.

6. The method of claim 1, wherein the computer-based system generates the dynamic PIN using a consumer profile associated with the account holder.
